(19) United States
(12) Patent Application Publication
(10) Pub. No.: US 2008/0044070 A1
(43) Pub. Date: Feb. 21, 2008

(54) Abnormal mass candidate detecting apparatus, method and computer-readable medium

(75) Inventor: Yao Nie, Sunnyvale, CA (US)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/504,630

(22) Filed: Aug. 16, 2006

(51) Int. Cl. G06K 9/00

(52) U.S. Cl. 382/128; 382/117

(57) ABSTRACT

An apparatus, a computer-readable medium and a method of detecting cancer masses using mammography are described. From an input image, an iris contrast map and an iris ring filter response map of the input image are generated. Potential abnormal mass candidates are identified by locating those masses whose iris contrast value above a predetermined contrast threshold and whose iris ring filter response is above a predetermined response threshold. After the potential abnormal mass candidates are identified, candidates that are less likely to be abnormal can be eliminated.

### FIELD OF THE INVENTION

The present invention relates to an apparatus, method and computer-readable medium for detecting abnormal mass candidates in an input image. Potentially cancerous mass in the input image is a type of an abnormal mass candidate. In particular, the present invention relates to detecting abnormal mass candidates by identifying masses in the input image with certain characteristics.

### BACKGROUND OF THE INVENTION

In medical fields, computer aided diagnosis (CAD) systems for automatically detecting an abnormal mass candidate embedded in an image, enhancing the detected abnormal mass candidate, and displaying a visible image containing the enhanced abnormal mass candidate are known. Medical doctors view the visible image containing the abnormal mass candidate having been detected with the CAD systems and make a final judgment as to whether the abnormal mass candidate contained in the image is or is not a true abnormal mass representing a diseased part, such as a cancerous mass.

Techniques for detecting abnormal mass candidates, for example, morphological filtering techniques are known. With the morphological filtering techniques, image processing with a morphological filter is performed on a breast image, threshold value processing is performed on output values of the morphological filter, and a candidate for a microcalcification mass (a form of the abnormal mass) is detected automatically.

Techniques utilizing subtraction processing is also known. With subtraction processing, a normal structure image corresponding to an inputted medical image is formed artificially, a subtraction image representing a difference between the inputted medical image and the normal structure image is formed, and a mass having pixel values at least equal a predetermined value in the subtraction image is detected as an abnormal mass candidate.

In any automated system, increasing the accuracy is desired.

### SUMMARY OF THE INVENTION

A method to detect an abnormal mass candidate from an input image according to an embodiment of the present invention comprises the steps of generating an input gradient vector map based on the input image, generating an iris contrast map based on the input gradient vector map, generating an iris ring filter response map based on the iris contrast map, and outputting, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.

The input gradient vector map may be a map of vector values of pixels of the input image. The vector value for each pixel may represent a direction and a magnitude of a change of the pixel in the input image within a small neighborhood of the pixel.

The iris contrast map may be a map of iris contrast values of the pixels of the input image. The iris contrast value for each pixel may represent a response value of a corresponding pixel in the input gradient vector map to an iris contrast filter.

The iris ring filter response map may be a map of iris ring filter response values of the pixels of the input image. The iris ring filter response value for each pixel may represents response value of a corresponding pixel in the iris contrast map to an iris ring filter.

An abnormal mass candidate detection apparatus according to an embodiment of the present invention comprises an input gradient vector map generating device configured to generate an input gradient vector map based on an input image, an iris contrast map generating device configured to generate an iris contrast map based on the input gradient vector map, an iris ring filter response map generating device configured to generate an iris ring filter response map based on the iris contrast map, and an abnormal mass candidate outputting device configured to output, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.

A computer-readable medium according to an embodiment of the present invention includes a program executable on a computer for detecting an abnormal mass candidate from an input image. The program comprises the steps of generating an input gradient vector map based on the input image, generating an iris contrast map based on the input gradient vector map, generating an iris ring filter response map based on the iris contrast map, and outputting, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.

These and other embodiments of the present invention enhances accuracy of detecting the abnormal mass candidates.

### BRIEF DESCRIPTION OF THE DRAWINGS

Features and advantages of the invention will become apparent to those skilled in the art from the following description with reference to the drawings, in which:

FIG. 1 illustrates a method of detecting abnormal mass candidates according to an embodiment of the present invention;

FIG. 2 illustrates another method of detecting abnormal mass candidates according to an embodiment of the present invention,

FIGS. 3A and 3B illustrate an example for determining a vector value of a pixel of an input image according to an embodiment of the present invention;

FIG. 4 illustrates a method of generating component maps of an input gradient vector map according to an embodiment of the present invention;

FIG. 5 illustrates an exemplary mask region of an iris contrast filter used to generate the input gradient vector map according to an embodiment of the present invention;

FIG. 6 illustrates an exemplary angular relationship between line segments of an iris contrast filter and gradient of a pixel of an input image according to an embodiment of the present invention;

FIG. 7A illustrates a method of generating an iris filter response map according to an embodiment of the present invention;

FIG. 7B illustrates an alternative method of generating the iris filter response map according to an embodiment of the present invention;

FIG. 8 illustrates an alternative process to generate an iris contrast map according to an embodiment of the present invention;

FIG. 9 illustrates a method to adjust magnitudes of vectors of pixels according to an embodiment of the present invention;

FIG. 10 illustrates a method to prune identified abnormal mass candidates according to an embodiment of the present invention;

FIG. 11 illustrates a method to enhance consistency of the abnormal mass identification process according to an embodiment of the present invention; and

FIG. 12 illustrates an apparatus to detect abnormal mass candidates from an input image according to an embodiment of the present invention.

### DETAILED DESCRIPTION

For simplicity and illustrative purposes, the principles of the invention are described by referring mainly to exemplary embodiments thereof. However, one of ordinary skill in the art would readily recognize that the same principles are equally applicable to many types of image analysis system and methods.

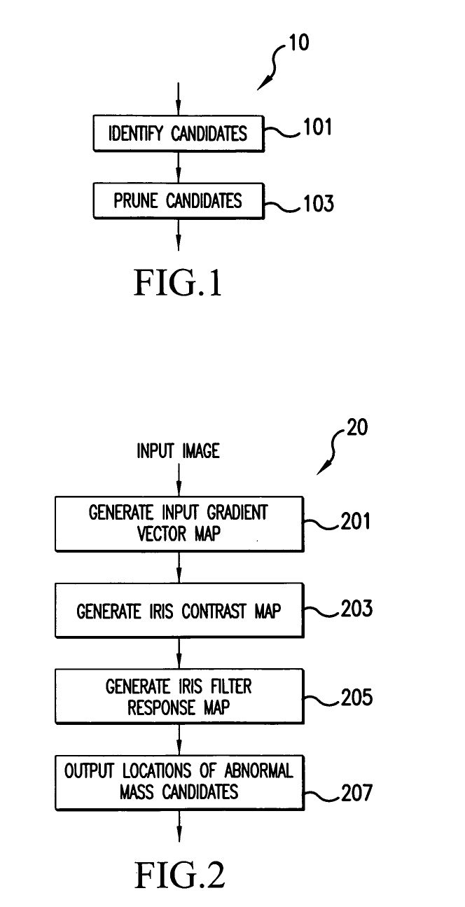

Generally, a method 10 of detecting abnormal mass candidates include two broad steps as illustrated in FIG. 1. First, abnormal mass candidates are identified from an input image such as a mammography image (step 101). An example of an abnormal mass is a cancerous tumor. After the abnormal mass candidates are identified, a pruning process may be performed to prune the candidates to those that are most likely to be abnormal masses (step 103).

FIG. 2 illustrates an exemplary method 20 to carry out the steps 101 and 103 of FIG. 1. As illustrated, an input gradient vector map is generated from an input image (step 201) such as a mammography image. The input gradient vector map may be described as a map of vector values of pixels of the input image. In other words, for each pixel of the input image, there is a corresponding vector value of the pixel in the input gradient vector map.

For each pixel, the vector value represents a change—in both direction and in magnitude—of the pixel within a small neighborhood of the pixel. The vector value includes two components—orientation angle φ of the vector and the magnitude A of the vector—and can be defined as follows:

$$\begin{matrix}φ = {tan}^{- 1} \frac{Δ y}{Δ x} & ( 1 ) \\ A = \sqrt{{( Δ x )}^{2} + {( Δ y )}^{2}} & ( 2 )\end{matrix}$$

where Δx and Δy represent the changes of the pixel in the x and y directions, respectively, within the small neighborhood of the pixel.

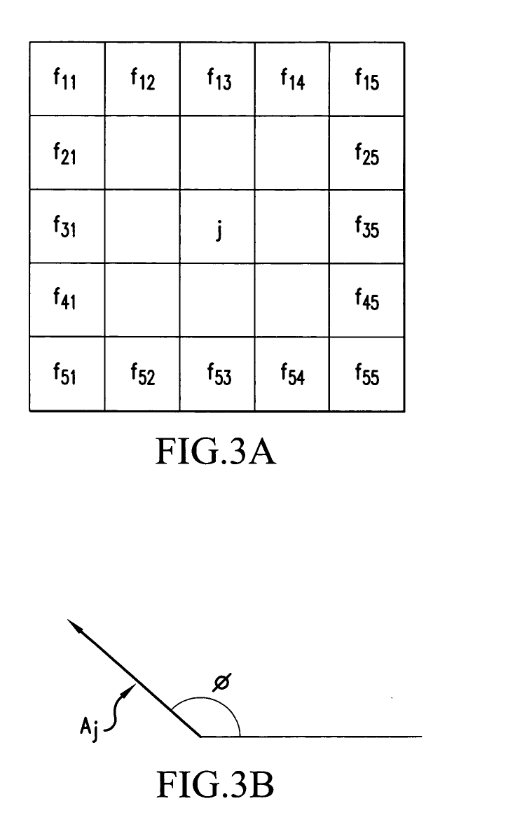

FIGS. 3A and 3B illustrate an example for determining the vector value of a pixel. For each pixel j in the input image, a square mask filter of size n×n may be centered on the pixel j as shown in FIG. 3A. In this instance, n is 5, Δx is defined to be (f₁₅+f₂₅+f₃₅+f₄₅+f₅₅)−(f₁₁+f₂₁+f₃₁+f₄₁+f₅₁), and Δy is defined to be (f₁₁+f₁₂+f₁₃+f₁₄+f₁₅)−(f₅₁+f₅₂+f₅₃+f₅₄+f₅₅). Then the orientation angle (or simply angle) φ and the magnitude of the vector can be calculated according to formulas (1) and (2) respectively. The calculated vector value is illustrated in FIG. 3B.

The size of the mask filter is not limited to the example as illustrated in FIGS. 3A and 3B. Indeed, the shape of the mask filter is also not limited. Mask filters of other shapes and sizes may be utilized to determine the vector value.

Further, determining vectors is not strictly limited to the use of filters. It is only necessary that the vector value represent the change of the pixel in a sufficiently localized area (i.e., within a small neighborhood) of the pixel. The scope of the invention fully encompasses any method and system that can be used to generate the vector values as described.

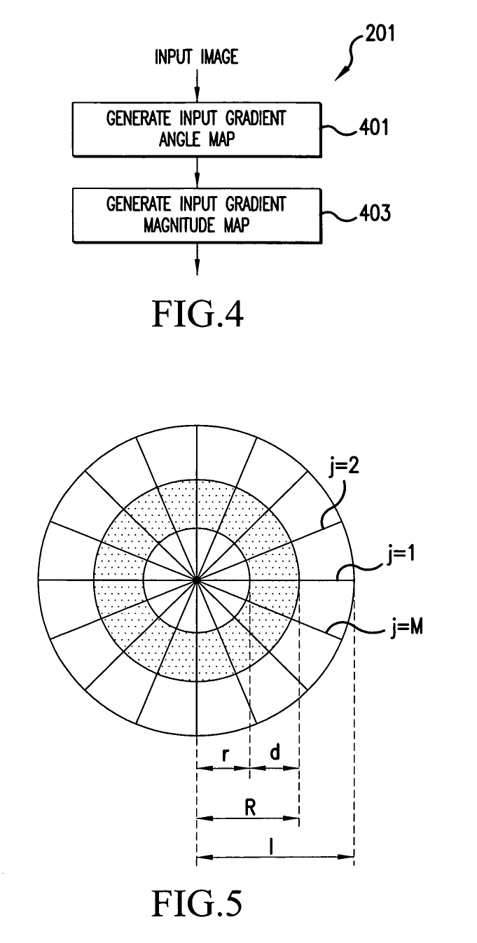

As noted above, the vector value includes two components—the angle φ and the magnitude A. Thus, generating the input gradient vector map can be achieved by generating two component maps as illustrated in FIG. 4. In FIG. 4, generating the input gradient vector map (step 201 of FIG. 2) may be accomplished by generating an input gradient angle map from the input image (step 401) and generating an input gradient magnitude map also from the input image (step 403). The input gradient angle and magnitude maps include the component angle and magnitude values, respectively, of the pixels of the input image. The order in which the input gradient angle and magnitude maps are generated is not limited to the embodiment as illustrated in FIG. 4.

Referring back to FIG. 2, once the input gradient vector map of the input image is generated, an iris contrast map may be generated from the input gradient vector map (step 203). The iris contrast map may be described as a map of iris contrast values of the pixels of the input image. The iris contrast value of a pixel may be described as a response of a corresponding pixel in the input gradient vector map to an iris contrast filter.

FIG. 5 illustrates an exemplary iris contrast filter with a mask region that may be applied to the pixels of the input gradient vector map. The mask region may be characterized by a ring (hashed portion). The parameters of the iris contrast filter include r (inner radius of the ring), d (width of the ring), R (outer radius of the ring), l (outer limits of the ring), and M (number of angles considered in the filtering process). The inner radius of the ring r may be adaptive and the width d of the ring may be fixed. As an example, the width d of the ring may be fixed to 5 pixels, l may be fixed at 25 pixels. In this instance, r may take on values ranging from 0 to 20 (0 to l−d). Also, M may be set to 16.

To generate the iris contrast map, for each pixel (x,y) in the input image, the iris contrast value C(x,y) of the pixel (x,y) may be determined by applying the iris contrast filter as follows:

$$\begin{matrix}C ( x , y ) = {max}_{0 \leq r \leq l - d} \frac{1}{d} {\sum }_{i = r + 1}^{R} {C}_{i} \\ where & ( 3 ) \\ {C}_{i} = \frac{1}{M} {\sum }_{j = 1}^{M} {A}_{ij} cos {θ}_{ij} & ( 4 )\end{matrix}$$

In formulas (3) and (4), Aᵢⱼ is a vector magnitude of a pixel i,j from the input gradient vector map and θᵢⱼ is an angle between a vector direction φᵢⱼ of the pixel i,j from the input gradient vector map and a line segment connecting the pixel i,j to a center of the iris contrast filter. Alternatively, the magnitude Aᵢⱼ and angle θᵢⱼ values may be determined from the individual component input gradient magnitude and angle maps (see FIG. 4).

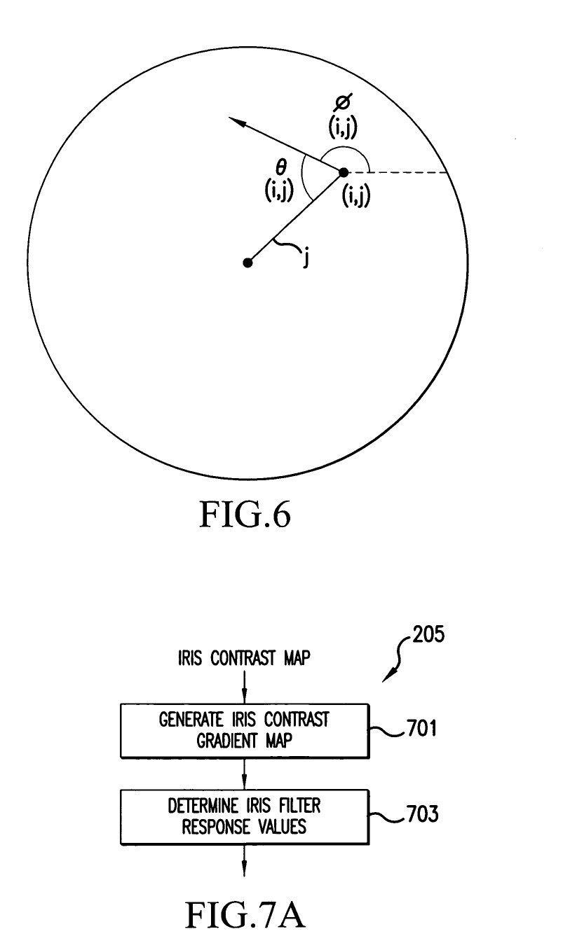

As indicated above, the angle θᵢⱼ is defined as the angle between the vector direction φᵢⱼ of the pixel i,j and the line segment connecting the pixel i,j to the center of the iris contrast filter. In FIG. 5, sixteen such line segments j (M=16) are illustrated. FIG. 6 illustrates the relationship between the angle θᵢⱼ used in formula (4) and the vector direction (orientation angle) φᵢⱼ of the pixel i,j on a particular line segment j.

Also as indicated above, M represents the number of angles considered in the filtering process. For example, when M is set to 16, then for each Cᵢ calculated using formula (4), only the pixels at radius i and angles 0, ±π/16, ±π/8, ±3π/16, ±π/4, ±5π/16, ±3π/8, ±7π/16, and π/2 from the pixel (x,y) of interest are considered in the calculation. However, it is contemplated that all pixels at radius i can be considered in determining Cᵢ. In this instance, M would simply represent the total number of pixels at radius i from the pixel of interest. Setting M to a specific number would result in a faster calculation, but may sacrifice accuracy. The number M may be chosen where the sacrifice in accuracy is ignorable for the particular application.

Referring back to FIG. 2, after the iris contrast map of the input image is generated, an iris filter response map may be generated from the iris contrast map (step 205). The iris filter response map may be described as a map of iris filter response values of the pixels of the input image. The iris filter response value of a pixel may be described as a response of a corresponding pixel in the iris contrast map to an iris ring filter.

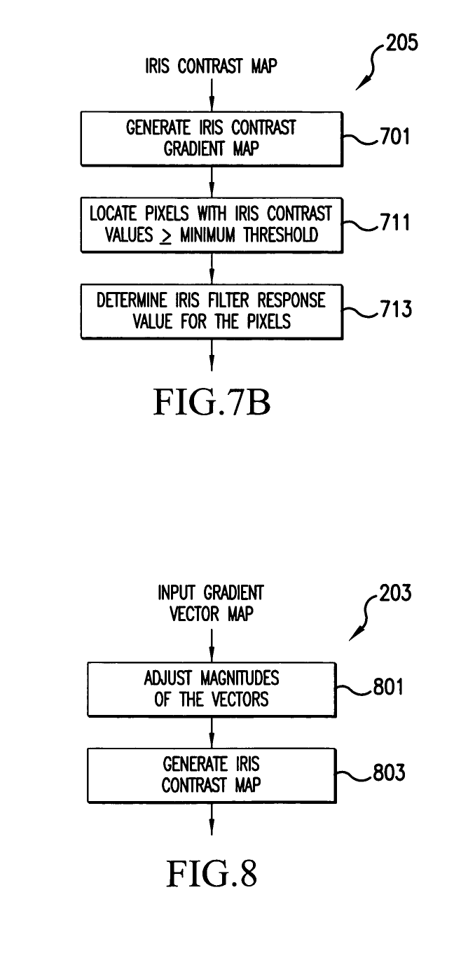

FIG. 7A illustrates an exemplary process to generate the iris filter response map (step 205 of FIG. 2). As shown, an iris contrast gradient angle map may be generated from the iris contrast map (step 701). The process to generate the iris contrast gradient map is similar to the process to generate the input gradient vector map as illustrated in FIGS. 3A and 3B. However, instead of the input image, the iris contrast map is used as the input in this process. Also, only the gradient angle values (i.e., contrast angles) need to be determined (see formula (1)).

For simplicity, the mask filter used to generate the input gradient vector map may also be used to generate the iris contrast gradient angle map. However, this is not strictly necessary, i.e., a completely different mask filter may be used.

Referring back to FIG. 7A, the iris filter response map may be generated by applying an iris ring filter to the iris contrast gradient angle map to determine the iris filter response values of the pixels (step 703). The iris ring filter can be similar to the iris contrast filter illustrated in FIG. 5, but need not be exactly the same. In other words, the values of parameters r, d, R, l, and M of the iris ring filter need not be the same as the corresponding parameters of the iris contrast filter.

The iris filter response value D(x,y) of a pixel (x,y) may be determined by applying an iris ring filter as follows:

$$\begin{matrix}D ( x , y ) = {max}_{0 \leq r \leq l - d} \frac{1}{M} {\sum }_{j = 0}^{M - 1} D j \\ where & ( 5 ) \\ {D}_{j} = \frac{1}{d} {\sum }_{i = r + 1}^{R} cos {θ}_{ij} & ( 6 )\end{matrix}$$

In formulas (5) and (6), θᵢⱼ is an angle between a direction of the pixel i,j from the iris contrast gradient angle map and a line segment connecting the pixel i,j to a center of the iris ring filter (see description of FIG. 5). Also, M is the number of angles considered in the filtering process. Like the situation regarding formulas (3) and (4), M may take on any specific value to indicate only certain angles are considered. Similarly, all angles may be considered as well. The choice to consider a fixed number of angles or all angles is a matter of computational efficiency and complexity.

Referring back to FIG. 2, after the iris filter response map is generated, the locations of the abnormal mass candidate locations may be outputted (step 207). Abnormal mass candidates may be determined to be those locations in which both of the following output conditions are true. First, the iris contrast value of the location (i.e. the pixel location) is greater than or equal to a minimum iris contrast threshold. Second, the iris ring filter response value of the location is greater than or equal to a minimum iris ring filter response threshold. The combination of the first and second conditions increases the overall accuracy of the method.

The method illustrated in FIG. 2 may be made more efficient. For example, FIG. 7B illustrates an alternative process to generate the iris filter response map. As shown, an iris contrast gradient angle map may be generated from the iris contrast map (step 701) just as in FIG. 7A. Afterwards, the pixels (or pixel locations) whose iris contrast values are greater than or equal to the minimum iris contrast threshold may be located (step 711). Then in step 713, the iris ring filter response values may be determined (formulas (5) and (6) applied) only for the pixels located in step 711. In this manner, the process may be sped up, i.e. made more efficient, since only those pixel locations that meet the first output condition are evaluated.

The method illustrated in FIG. 2 also includes alternatives. As noted above, the iris filter response value D(x,y) of a pixel (x,y) may be determined by applying an iris ring filter to formulas (5) and (6). However, as an alternative, the response value D(x,y) of the pixel may be determined by applying a half-ring iris filter as follows:

$$\begin{matrix}D ( x , y ) = {max}_{0 \leq r \leq l - d} \{ {max}_{0 \leq k \leq M - 1} \frac{1}{M / 2} {\sum }_{j = k}^{mod ( k + M / 2 - 1 , M )} D j \} \\ where & ( 7 ) \\ {D}_{j} = \frac{1}{d} {\sum }_{i = r + 1}^{R} cos {θ}_{ij} & ( 8 )\end{matrix}$$

In formulas (7) and (8), θᵢⱼ is an angle between a direction of the pixel i,j from the iris contrast gradient angle map and a line segment connecting the pixel i,j to a center of the half-ring iris ring filter (see description of FIG. 5). Note that formulas (7) and (8) may be applied to only those pixel locations with iris contrast values greater than or equal to the minimum iris contrast threshold to make the method more efficient.

As another alternative, the accuracy of the method may be enhanced by adjusting the magnitudes of the input gradient vector map prior to generating the iris contrast map. FIG. 8 illustrates an alternative process to generate the iris contrast map. In FIG. 8, the magnitudes of the vectors values of the input gradient vector map may be adjusted (step 801). The iris contrast map may then be generated from the adjusted input gradient vector map (step 803).

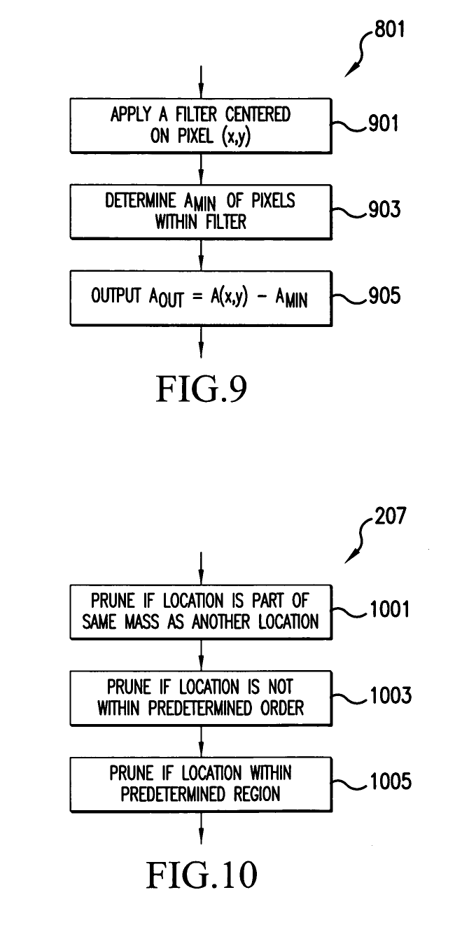

In particular, the magnitudes may be adjusted as illustrated in FIG. 9. For each pixel (x,y) of the input gradient vector map, a mask filter may be centered on the pixel (step 901). The mask filter may be a square filter similar to the filter illustrated in FIG. 3A. However, the size and shape of the mask filter for this process is not so limited. Then the minimum magnitude Amin may be found for the pixels within the filter (step 903). The adjusted magnitude Aout of the pixel (x,y) may be calculated to be Axy−Amin, where Axy is the magnitude of the pixel vector prior to adjustment (step 905).

The reason for such adjustment is based on the observation that in the region near the skin line, the gradient vectors have similarly valued magnitude. Thus, the difference between Axy and Amin is small, which leads to a low valued Aout to suppress false gradient vectors in the region. In the center region of the breast, breast tissue or cancer mass pixels and fatty area pixels both may be present in any local area. Usually, Amin corresponds to fatty area pixels and is very small. Therefore, Aout is almost the same as Axy. Thus, the desired gradient information in the area of interest is preserved.

If component maps of the input gradient vector maps are used, only the input gradient magnitude map may need to be adjusted.

In the above description, the iris contrast map (step 203 of FIG. 2) may be generated by applying the iris contrast filter of FIG. 5 and formulas (3) and (4) on the pixels of the input gradient vector map. As an alternative, the iris contrast map may be generated by applying formulas (9) and (10) using a similar iris contrast filter as noted below.

$$\begin{matrix}C ( x , y ) = {max}_{0 \leq r \leq l - d} \frac{1}{d} {\sum }_{i = r + 1}^{R} {C}_{i} \\ wherein & ( 9 ) \\ {C}_{i} = median \{ {A}_{ij} cos {θ}_{ij} , j = 1 , 2 , … , M \} & ( 10 )\end{matrix}$$

In formulas (9) and (10), Aᵢⱼ is a vector magnitude of a pixel i,j from the input gradient vector map and θᵢⱼ is an angle between a vector direction of the pixel i,j from the input gradient vector map and a line segment connecting the pixel i,j to a center of the iris contrast filter. Alternatively, the magnitude Aᵢⱼ and angle θᵢⱼ values may be determined from the individual component input gradient magnitude and angle maps.

The iris contrast map that results from applying formulas (9) and (10) may be described as an iris contrast map of median iris contrast values of the pixels of the input, or simply as a median iris contrast map. The median iris contrast values may be compared to the minimum median iris contrast threshold to determine whether or not the first output condition is met.

Both the iris contrast output and the median iris contrast output are sensitive, i.e. have high responses, to circular edges of the input image—in this instance the input gradient vector map. The abnormal mass candidates of interest are typically characterized as having circular shapes, thus sensitivity to circular edges is advantageous and the accuracy of the system may be enhanced through utilizing either of the iris contrast output or the median iris contrast output.

However, the median iris contrast has one advantage over the iris contrast output. Normal masses, which are not of interest, are typically non-circular. However, if the gradient magnitude is large, the iris contrast output may have high responses to the non-circular masses. On the other hand, the median iris contrast output has lower responses to non-circular masses than the iris contrast output. Thus, median iris contrast map is generally less noisy (or more accurate) than iris contrast map.

As a refinement to generating the median iris contrast map, the vector magnitude Aᵢⱼ used in determining the Cᵢ in formula (10) may be adjusted as follows:

$${A}_{ij} = \{ \begin{matrix}{A}_{ij} , & {A}_{ij} < A max \\ {A}_{ij} \cdot exp ( - {( {A}_{ij} - A max )}^{2} / B ) , & else\end{matrix} \qquad ( 11 )$$

The magnitude adjustment formula (11) is based on the observation that a very strong gradient is less likely to result from a cancer mass. The values Amax and B may be chosen to suppress the strong gradients to minimize incidences of false positive identifications of abnormal mass candidates. The parameter Amax may be represent a gradient magnitude value for which typical abnormal mass edge would not exceed. The parameter B may represent a spread of a Gaussian function and may be experimentally determined.

If the magnitude Aᵢⱼ is to be adjusted according to the formula (11), it is preferred that magnitude is adjusted as illustrated in FIGS. 8 and 9 prior to adjusting the magnitude according to the formula (11).

Referring back to FIG. 2, in the step of generating the iris filter response map (step 205), the median iris contrast map may be used instead of the iris contrast map. More specifically, the iris contrast gradient map may be generated (step 701 of FIG. 7A) from the median iris contrast map and the iris filter response values may be determined from the iris contrast gradient map (step 703). The median iris contrast map is also applicable to the enhanced efficiency process illustrated in FIG. 7B. Yet further, the half-ring iris ring filter (see formulas (7) and (8)) can be applied to the median iris contrast map to generate the iris ring filter response map.

After the iris ring filter response map is generated, one or more pixel locations of the input image that satisfies both the first and second output conditions may be identified as abnormal mass candidates (step 207 of FIG. 2). The accuracy and usefulness may be enhanced through pruning of the identified locations.

FIG. 10 illustrates some of the pruning process that can be included. For each pixel location identified as a potential abnormal mass candidate, it may be pruned (eliminated) if it is part of a mass already identified as abnormal by another pixel location (step 1001). For example, the abnormal mass candidates of interest may be characterized as being a certain minimum size. Thus, if two identified locations are within a predetermined distance of each other, then the two locations are likely to be parts of the same abnormal mass. The usefulness may be enhanced by reducing the likelihood of multiple identifications of the same mass.

Also, an end user may be interested in only the predetermined number of most likely candidates. Among all locations that satisfy both the first and second output conditions, the locations may be ordered based on the likelihood of the locations being abnormal. The likelihood may be determined solely from the iris contrast values, solely from the iris ring filter response values, or a combination of both. If both are used, each value may be weighted to determine the order. Once the order of the locations is determined, then the top predetermined number of locations may be output as abnormal mass candidates (step 1003).

There may be situations in which there are locations that satisfy the first output condition, but the same locations do not meet the second output condition. In this instance, the second output condition—the minimum iris ring filter response threshold—may be relaxed so that one or more locations that meet the first output condition may be identified as abnormal mass candidate.

Further, there are regions of the body that are less likely to have abnormal masses than others. The examples of such regions include chest wall, shoulder, skin line, and pectoral muscles. If the pixel location falls within any of these predetermined regions, the location may be pruned (step 1005).

It is contemplated that not all pruning steps 1001, 1003 and 1005 need to be performed. Also, the order of the pruning steps is not limited to the order illustrated in FIG. 10. The steps may be performed simultaneously or serially, or not at all.

As another enhancement, the minimum iris contrast threshold may be set according to the characteristics of the input image. It is generally recognized that different input images have differing characteristics. Thus the ranges of iris contrast values are likely to differ from one input image to the next. If the minimum contrast threshold is fixed for all input images, then under identification or over identification of abnormal mass candidates can result.

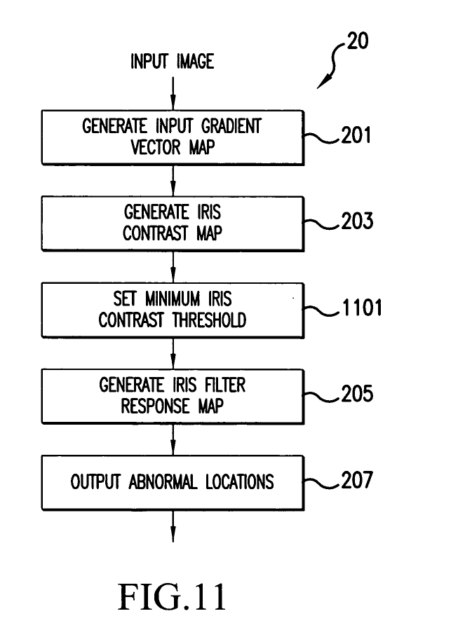

One way to enhance the consistency of identification of abnormal mass candidates may be to adjust the minimum iris contrast threshold based on the iris contrast map generated from the input image. FIG. 11 illustrates this enhanced process. As illustrated, FIG. 11 is identical to FIG. 2 except that after generating the iris contrast map (step 203) and before generating the iris filter response map (step 205), the minimum iris contrast level may be set based on one or more characteristics of the input image (step 1101).

For example, it may be that within a given image, only a top few percent of iris contrast values are like to be truly abnormal. It may be that only the highest five percent of iris contrast values are of interest for instance. In this circumstance, the minimum iris contrast level may be set to the 95^{th} percentile level.

As another example, it may be that only a predetermined number of most likely candidates are to be identified. Then the minimum iris contrast threshold may be set to a level such that only the predetermined number of locations in the iris contrast map have the iris contrast values greater than or equal to the level.

By setting the minimum iris contrast threshold, consistency in abnormal identification results may be achieved across the range in input images. Similar considerations may be given to set the minimum iris ring filter response threshold to further enhance the consistency.

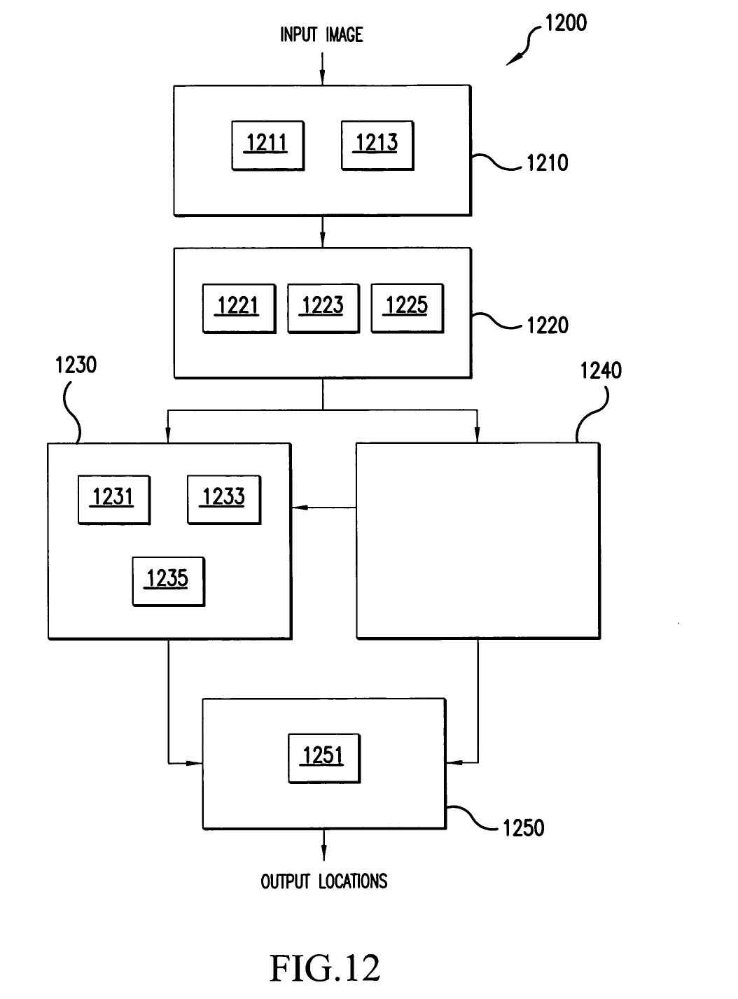

FIG. 12 illustrates an apparatus 1200 to detect abnormal mass candidates from an input image. The apparatus 1200 may include an input gradient vector map generating device 1210, an iris contrast map generating device 1220, an iris filter response map generating device 1230, a minimum iris contrast threshold setting device 1240, and an abnormal mass candidate outputting device 1250.

The input gradient vector map generating device 1210 may be configured to generate the input gradient vector map from the input image. The input gradient vector map generating device 1210 may include an input gradient angle map generating device 1211 and an input gradient magnitude map generating device 1213 configured to generate the component maps of the input gradient vector map.

The iris contrast map generating device 1220 may be configured to generate the iris contrast map based on the input gradient vector map generated by the input gradient vector map generating device 1210. The iris contrast map generating device 1220 may include an iris contrast filtering device 1221 and/or a median iris contrast filtering device 1223. The iris contrast filtering device 1221 may be configured to determine the iris contrast response values of pixels based on formulas (3) and (4) and the median iris contrast filtering device 1223 may be configured to determine the median iris contrast response values of pixels based on formulas (9) and (10). The iris contrast map generating device 1220 may further include a gradient magnitude adjusting device 1225 configured to adjust the magnitudes of the input gradient vector map in accordance with the result of the process illustrated in FIGS. 8 and 9 and/or in accordance with the formula (11).

The iris filter response map generating device 1230 may be configured to generate the iris filter response map based on the input contrast map generated by the iris contrast map generating device 1220. The iris filter response map generating device 1230 may include an iris ring filtering device 1231 and/or a half-ring iris filtering device 1233. The iris ring filtering device 1231 may be configured to determine the iris ring filter response values of pixels based on formulas (5) and (6) and the half-ring iris filtering device 1233 may be configured to determine the half-ring iris ring filter response values of pixels based on formulas (7) and (8). The iris filter response map generating device 1235 may further include an iris contrast gradient angle map generating device configured to generate the iris contrast gradient angle map, which may be used as input to the iris ring filtering device 1231 and/or to the half-ring iris filtering device 1233 to generate the iris filter response map.

The minimum iris contrast threshold setting device 1240 may be configured to set the minimum iris contrast threshold based on the input contrast map generated by the iris contrast map generating device 1220 in accordance with the results of the step 1101 of FIG. 11.

The abnormal mass candidate outputting device 1250 may be configured to output the locations of pixels that satisfy both the first and second output conditions as abnormal mass candidates in accordance with step 207 (see FIGS. 2 and 11). The abnormal mass candidate outputting device 1250 may include a pruning device 1251 configured to prune the candidate locations in accordance with the results of any one or more of steps 1001, 1003 and 1005 (see FIG. 10).

The method to identify abnormal mass candidates may be recorded as a program in a computable-readable medium such that when executed, the computer device is able to identify abnormal mass candidates.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method to detect an abnormal mass candidate from an input image, comprising:
generating an input gradient vector map based on the input image, wherein the input gradient vector map is a map of vector values of pixels of the input image, and wherein the vector value for each pixel represents a direction and a magnitude of a change of the pixel in the input image within a small neighborhood of the pixel;
generating an iris contrast map based on the input gradient vector map, wherein the iris contrast map is a map of iris contrast values of the pixels of the input image, and wherein the iris contrast value for each pixel represents a response value of a corresponding pixel in the input gradient vector map to an iris contrast filter;
generating an iris ring filter response map based on the iris contrast map, wherein the iris ring filter response map is a map of iris ring filter response values of the pixels of the input image, and wherein the iris ring filter response value for each pixel represents a response value of a corresponding pixel in the iris contrast map to an iris ring filter; and
outputting, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.

2. The method of claim 1, wherein the step of generating the input gradient vector map comprises:
generating an input gradient angle map based on the input image, wherein the input gradient angle map is a map of angles of the pixels of the input image, and wherein the angle for each pixel represents the direction of the change of the pixel in the input image within the small neighborhood of the pixel; and
generating an input gradient magnitude map based on the input image, wherein the input gradient magnitude map is a map of scalar values of the pixels of the input image, and wherein the scalar value for each pixel represents the magnitude of the change of the pixel in the input image within the small neighborhood of the pixel.

3. The method of claim 1, wherein the step of generating the iris contrast map comprises:
outputting a response C(x,y) by applying the iris contrast filter for each
$$C ( x , y ) = {max}_{0 \leq r \leq l - d} \frac{1}{d} {\sum }_{i = r + 1}^{R} {C}_{i}$$
pixel location of the input image such that
$${C}_{i} = \frac{1}{M} {\sum }_{j = 1}^{M} {A}_{ij} cos {θ}_{ij} ,$$
wherein C(x,y) is the iris contrast value of the pixel location, Aᵢⱼ is a vector magnitude of a pixel i,j from the input gradient vector map, θᵢⱼ is an angle between a vector direction of the pixel i,j from the input gradient vector map and a line segment connecting the pixel i,j to a center of the iris contrast filter, r is an inner radius of the iris contrast filter, d is a width of a ring of the iris contrast filter, R is an outer radius of the iris contrast filter such that R=r+d, l is an upper limit of R, and M is a number of directions,
wherein the iris contrast filter is centered on the pixel location (x,y), and
wherein r is adaptive and d is fixed.

4. The method of claim 3, wherein the step of generating the iris ring filter response map comprises:
generating an iris contrast gradient angle map based on the iris contrast map, wherein the iris contrast gradient angle map is a map of contrast angles of the pixels of the input image, and wherein the contrast angle for each pixel represents a direction of a change of a corresponding pixel in the iris contrast map within a small neighborhood of the corresponding pixel; and
outputting a response D(x,y) through one of
applying the iris ring filter for each pixel location such that
$$D ( x , y ) = {max}_{0 \leq r \leq l - d} \frac{1}{M} {\sum }_{j = 0}^{M - 1} Dj$$
$${D}_{j} = \frac{1}{d} {\sum }_{i = r + 1}^{R} cos {θ}_{ij} , or$$
applying a half-ring iris ring filter for each pixel location such that
$$D ( x , y ) = {max}_{0 \leq r \leq l - d} \{ {max}_{0 \leq k \leq M - 1} \frac{1}{M / 2} {\sum }_{j = k}^{mod ( k + M / 2 - 1 , M )} Dj \}$$
$${D}_{j} = \frac{1}{d} {\sum }_{i = r + 1}^{R} cos {θ}_{ij} ,$$
wherein D(x,y) is the iris filter response value of the pixel location, θᵢⱼ is an angle between the contrast angle of a pixel i,j from the iris contrast gradient angle map and a line segment connecting the pixel ij to a center of the iris ring filter or the half-ring iris ring filter, r is an inner radius of the iris ring filter or the half-ring iris ring filter, d is a width of a ring of the iris ring filter or the half-ring iris ring filter, R is an outer radius of the iris ring filter or the half-ring iris ring filter such that R=r+d, l is an upper limit of R, and M is a number of directions, and
wherein the iris ring filter or the half-ring iris ring filter is centered on the pixel location (x,y), and
wherein r is adaptive and d is fixed.

5. The method of claim 4, wherein the step of generating the iris ring filter response map further comprises:
selecting one or more pixel locations each of whose iris contrast value is greater than equal to the minimum iris contrast threshold; and
outputting the responses D(x,y) only for the selected pixel locations.

6. The method of claim 3, wherein the step of generating the iris contrast map further comprises:
adjusting the input gradient vector map prior to applying the iris contrast filter,
wherein the step of adjusting the input gradient vector map comprises performing for each pixel (x,y) of the input gradient vector map:
centering a mask filter of a predetermined size on the pixel (x,y);
determining Amin, wherein Amin is a minimum magnitude of the pixels within the mask filter from the input gradient vector map; and
outputting adjusted magnitude Aout for the pixel such that Aout=Axy−Amin, wherein Axy is the magnitude of the pixel (x,y) from the input gradient vector map.

7. The method of claim 1, wherein the step of generating the iris contrast map comprises:
outputting a response C(x,y) by applying the iris contrast filter for each pixel location of the input image such that
$$C ( x , y ) = {max}_{0 \leq r \leq l - d} \frac{1}{d} {\sum }_{i = r + 1}^{R} {C}_{i}$$
$${C}_{i} = median \{ {A}_{ij} cos {θ}_{ij} , j = 1 , 2 , … , M \} ,$$
wherein C(x,y) is the iris contrast value of the pixel location, Aᵢⱼ is a vector magnitude of a pixel i,j from the input gradient vector map, θᵢⱼ is an angle between a vector direction of the pixel i,j from the input gradient vector map and a line segment connecting the pixel i,j to a center of the iris contrast filter, r is an inner radius of the iris contrast filter, d is a width of a ring of the iris contrast filter, R is an outer radius of the iris contrast filter such that R=r+d, l is an upper limit of R, and M is a number of directions,
wherein the iris contrast filter is centered on the pixel location (x,y), and
wherein r is adaptive and d is fixed.

8. The method of claim 7, wherein the step of generating the iris contrast map further comprises:
adjusting the vector magnitude Aᵢⱼ of the pixel i,j from the input gradient vector map such that
$${A}_{ij} = \{ \begin{matrix}{A}_{ij} , & {A}_{ij} < A max \\ {A}_{ij} \cdot exp ( - {( {A}_{ij} - A max )}^{2} / B ) , & else\end{matrix}$$
prior to applying the iris contrast filter to output C(x,y),
wherein Amax is a predetermined maximum magnitude value and B is a predetermined divisor.

9. The method of claim 7, wherein the step of generating the iris ring filter response map comprises:
generating an iris contrast gradient angle map based on the iris contrast map, wherein the iris contrast gradient angle map is a map of contrast angles of the pixels of the input image, and wherein the contrast angle for each pixel represents a direction of a change of a corresponding pixel in the iris contrast map within a small neighborhood of the corresponding pixel; and
outputting a response D(x,y) through one of
applying the iris ring filter for each pixel location such that
$$D ( x , y ) = {max}_{0 \leq r \leq l - d} \frac{1}{M} {\sum }_{j = 0}^{M - 1} Dj$$
$${D}_{j} = \frac{1}{d} {\sum }_{i = r + 1}^{R} cos {θ}_{ij} , or$$
applying a half-ring iris ring filter for each pixel location such that
$$D ( x , y ) = {max}_{0 \leq r \leq l - d} \{ {max}_{0 \leq k \leq M - 1} \frac{1}{M / 2} {\sum }_{j = k}^{mod ( k + M / 2 - 1 , M )} Dj \}$$
$${D}_{j} = \frac{1}{d} {\sum }_{i = r + 1}^{R} cos {θ}_{ij} ,$$
wherein D(x,y) is the iris filter response value of the pixel location, θᵢⱼ is an angle between the contrast angle of a pixel i,j from the iris contrast gradient angle map and a line segment connecting the pixel i,j to a center of the iris ring filter or the half-ring iris ring filter, r is an inner radius of the iris ring filter or the half-ring iris ring filter, d is a width of a ring of the iris ring filter or the half-ring iris ring filter, R is an outer radius of the iris ring filter or the half-ring iris ring filter such that R=r+d, l is an upper limit of R, and M is a number of directions, and
wherein the iris ring filter or the half-ring iris ring filter is centered on the pixel location (x,y), and
wherein r is adaptive and d is fixed.

10. The method of claim 9, wherein the step of generating the iris ring filter response map further comprises:
selecting one or more pixel locations each of whose iris contrast value is greater than equal to the minimum iris contrast threshold; and
outputting the responses D(x,y) only for the selected pixel locations.

11. The method of claim 7, wherein the step of generating the iris contrast map further comprises:
adjusting the input gradient vector map prior to applying the iris contrast filter,
wherein the step of adjusting the input gradient vector map comprises performing for each pixel (x,y) of the input gradient vector map:
centering a mask filter of a predetermined size on the pixel (x,y);
determining Amin, wherein Amin is a minimum magnitude of the pixels within the mask filter from the input gradient vector map; and
outputting adjusted magnitude Aout for the pixel such that Aout=Axy−Amin, wherein Axy is the magnitude of the pixel (x,y) from the input gradient vector map.

12. The method of claim 1, wherein the step of outputting the location as the abnormal mass candidate comprises:
determining whether the location is part of a mass already identified as being abnormal by another location of the input image; and
outputting the location as the abnormal mass candidate when it is determined that the location is not part of the mass already identified as being abnormal by the another location of the input image.

13. The method of claim 12, wherein the step of determining whether the location is part of the mass already identified as being abnormal comprises:
determining whether the location is within a minimum threshold distance from the another location; and
determining that the location is part of the already identified mass when it is determined that the location is within the minimum threshold distance from the another location.

14. The method of claim 1, wherein the location is one of a plurality of abnormal mass candidates, the step of outputting the location as the abnormal mass candidate comprises:
determining an order of the location among the plurality of the abnormal mass candidates based on one or both of the iris contrast map value and the iris ring filter response value corresponding to the location; and
outputting the location as the abnormal mass candidate when the order of the location is within a predetermined maximum number of candidates.

15. The method of claim 1, wherein the step of outputting the location as the abnormal mass candidate comprises:
determining whether the location is within a predetermined region, wherein the predetermined region is at least one of a chest wall region, a shoulder region, a skin line region, and a pectoral muscle region; and
outputting the location as the abnormal mass candidate when it is determined that the location is not within the predetermined region.

16. The method of claim 1, further comprising:
determining a contrast value level from the iris contrast map such that only a predetermined number of locations or only a predetermined percentage of locations of the input image have iris contrast values greater than or equal to the contrast value level; and
setting the contrast value level as the minimum iris contrast threshold.

17. An abnormal mass candidate detection apparatus, comprising:
an input gradient vector map generating device configured to generate an input gradient vector map based on an input image, wherein the input gradient vector map is a map of vector values of pixels of the input image, and wherein the vector value for each pixel represents a direction and a magnitude of a change of the pixel in the input image within a small neighborhood of the pixel;
an iris contrast map generating device configured to generate an iris contrast map based on the input gradient vector map, wherein the iris contrast map is a map of iris contrast values of the pixels of the input image, and wherein the iris contrast value for each pixel represents a response value of a corresponding pixel in the input gradient vector map to an iris contrast filter;
an iris ring filter response map generating device configured to generate an iris ring filter response map based on the iris contrast map, wherein the iris ring filter response map is a map of iris ring filter response values of the pixels of the input image, and wherein the iris ring filter response value for each pixel represents a response value of a corresponding pixel in the iris contrast map to an iris ring filter; and
an abnormal mass candidate outputting device configured to output, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.

18. The apparatus of claim 17, wherein the iris contrast map generating device comprises:
an iris contrast filtering device configured to output a response C(x,y) by applying the iris contrast filter for each pixel location of the input image such
$$C ( x , y ) = {max}_{0 \leq r \leq l - d} \frac{1}{d} {\sum }_{i = r + 1}^{R} {C}_{i}$$
$$that$$
$${C}_{i} = \frac{1}{M} {\sum }_{j = 1}^{M} {A}_{ij} cos {θ}_{ij} ,$$
wherein C(x,y) is the iris contrast value of the pixel location, Aᵢⱼ is a vector magnitude of a pixel i,j from the input gradient vector map, θᵢⱼ is an angle between a vector direction of the pixel i,j from the input gradient vector map and a line segment connecting the pixel i,j to a center of the iris contrast filter, r is an inner radius of the iris contrast filter, d is a width of a ring of the iris contrast filter, R is an outer radius of the iris contrast filter such that R=r+d, l is an upper limit of R, and M is a number of directions,
wherein the iris contrast filter is centered on the pixel location (x,y), and
wherein r is adaptive and d is fixed.

19. The apparatus of claim 18, wherein the iris ring filter response map generating device comprises:
an iris contrast gradient angle map generating device configured to generate an iris contrast gradient angle map based on the iris contrast map, wherein the iris contrast gradient angle map is a map of contrast angles of the pixels of the input image, and wherein the contrast angle for each pixel represents a direction of a change of a corresponding pixel in the iris contrast map within a small neighborhood of the corresponding pixel; and
an iris ring filtering device or a half-ring iris ring filtering device or both,
wherein the iris filtering device is configured to output a response D(x,y) by applying an iris ring filter for each pixel location such that
$$D ( x , y ) = {max}_{0 \leq r \leq l - d} \frac{1}{M} {\sum }_{j = 0}^{M - 1} Dj$$
$${D}_{j} = \frac{1}{d} {\sum }_{i = r + 1}^{R} cos {θ}_{ij} ,$$
wherein the half-ring iris ring filtering device is configured to output the response D(x,y) by applying a half-ring iris ring filter for each pixel location such that
$$D ( x , y ) = {max}_{0 \leq r \leq l - d} \{ {max}_{0 \leq k \leq M - 1} \frac{1}{M / 2} {\sum }_{j = k}^{mod ( k + M / 2 - 1 , M )} Dj \}$$
$${D}_{j} = \frac{1}{d} {\sum }_{i = r + 1}^{R} cos {θ}_{ij} ,$$
wherein D(x,y) is the iris filter response value of the pixel location, θᵢⱼ is an angle between the contrast angle of a pixel i,j from the iris contrast gradient angle map and a line segment connecting the pixel i,j to a center of the iris ring filter or the half-ring iris ring filter, r is an inner radius of the iris ring filter or the half-ring iris ring filter, d is a width of a ring of the iris ring filter or the half-ring iris ring filter, R is an outer radius of the iris ring filter or the half-ring iris ring filter such that R=r+d, l is an upper limit of R, and M is a number of directions, and
wherein the iris ring filter or the half-ring iris ring filter is centered on the pixel location (x,y), and
wherein r is adaptive and d is fixed.

20. The apparatus of claim 18, wherein the iris contrast map generating device further comprises:
a gradient magnitude adjusting device configured to adjust the input gradient vector map from the input gradient vector map generating device,
wherein the adjusted input gradient vector map is provided to the iris contrast filtering device, and
wherein the gradient magnitude adjusting device is configured to adjust the input gradient vector map by performing for each pixel (x,y) of the input gradient vector map:
centering a mask filter of a predetermined size on the pixel (x,y);
determining Amin, wherein Amin is a minimum magnitude of the pixels within the mask filter from the input gradient vector map; and
outputting adjusted magnitude Aout for the pixel such that Aout=Axy−Amin, wherein Axy is the magnitude of the pixel (x,y) from the input gradient vector map.

21. The apparatus of claim 17, wherein the iris contrast map generating device comprises:
a median iris contrast filtering device configured to output a response C(x,y) by applying the iris contrast filter for each pixel location of the input image such that
$$C ( x , y ) = {max}_{0 \leq r \leq l - d} \frac{1}{d} {\sum }_{i = r + 1}^{R} {C}_{i}$$
$${C}_{i} = median \{ {A}_{ij} cos {θ}_{ij} , j = 1 , 2 , … , M \} ,$$
wherein C(x,y) is the iris contrast value of the pixel location, Aᵢⱼ is a vector magnitude of a pixel i,j from the input gradient vector map, θᵢⱼ is an angle between a vector direction of the pixel i,j from the input gradient vector map and a line segment connecting the pixel i,j to a center of the iris contrast filter, r is an inner radius of the iris contrast filter, d is a width of a ring of the iris contrast filter, R is an outer radius of the iris contrast filter such that R=r+d, l is an upper limit of R, and M is a number of directions,
wherein the iris contrast filter is centered on the pixel location (x,y), and
wherein r is adaptive and d is fixed.

22. The apparatus of claim 21, wherein the iris contrast map generating device further comprises:
a gradient magnitude adjusting device configured to adjust the input gradient vector map from the input gradient vector map generating device,
wherein the adjusted input gradient vector map is provided to the median iris contrast filtering device, and
wherein the gradient magnitude adjusting device is configured to adjust the input gradient vector map by performing for each pixel i,j of the input gradient vector map, adjusting the vector magnitude Aᵢⱼ of the pixel i,j from the input gradient vector map such that
$${A}_{ij} = \{ \begin{matrix}{A}_{ij} , & {A}_{ij} < A max \\ {A}_{ij} \cdot exp ( - {( {A}_{ij} - A max )}^{2} / B ) , & else\end{matrix}$$
prior to applying the iris contrast filter to output C(x,y), where Amax is a predetermined maximum magnitude value and B is a predetermined divisor.

23. The apparatus of claim 21, wherein the iris filter response map generating comprises:
an iris contrast gradient angle map generating device configured to generate an iris contrast gradient angle map based on the iris contrast map, wherein the iris contrast gradient angle map is a map of contrast angles of the pixels of the input image, and wherein the contrast angle for each pixel represents a direction of a change of a corresponding pixel in the iris contrast map within a small neighborhood of the corresponding pixel; and
an iris ring filtering device or a half-ring iris ring filtering device or both,
wherein the iris filtering device is configured to output a response D(x,y) by applying an iris ring filter for each pixel location such that
$$D ( x , y ) = {max}_{0 \leq r \leq l - d} \frac{1}{M} {\sum }_{j = 0}^{M - 1} Dj$$
$${D}_{j} = \frac{1}{d} {\sum }_{i = r + 1}^{R} cos {θ}_{ij} ,$$
wherein the half-ring iris ring filtering device is configured to output the response D(x,y) by applying a half-ring iris ring filter for each pixel location such that
$$D ( x , y ) = {max}_{0 \leq r \leq l - d} \{ {max}_{0 \leq k \leq M - 1} \frac{1}{M / 2} {\sum }_{j = k}^{mod ( k + M / 2 - 1 , M )} Dj \}$$
$${D}_{j} = \frac{1}{d} {\sum }_{i = r + 1}^{R} cos {θ}_{ij} ,$$
wherein D(x,y) is the iris filter response value of the pixel location, θᵢⱼ is an angle between the contrast angle of a pixel i,j from the iris contrast gradient angle map and a line segment connecting the pixel i,j to a center of the iris ring filter or the half-ring iris ring filter, r is an inner radius of the iris ring filter or the half-ring iris ring filter, d is a width of a ring of the iris ring filter or the half-ring iris ring filter, R is an outer radius of the iris ring filter or the half-ring iris ring filter such that R=r+d, l is an upper limit of R, and M is a number of directions, and
wherein the iris ring filter or the half-ring iris ring filter is centered on the pixel location (x,y), and
wherein r is adaptive and d is fixed.

24. The apparatus of claim 21, wherein the iris contrast map generating device further comprises:
a gradient magnitude adjusting device configured to adjust the input gradient vector map from the input gradient vector map generating device,
wherein the adjusted input gradient vector map is provided to the iris contrast filtering device, and
wherein the gradient magnitude adjusting device is configured to adjust the input gradient vector map by performing for each pixel (x,y) of the input gradient vector map:
centering a mask filter of a predetermined size on the pixel (x,y);
determining Amin, wherein Amin is a minimum magnitude of the pixels within the mask filter from the input gradient vector map; and
outputting adjusted magnitude Aout for the pixel such that Aout=Axy−Amin, wherein Axy is the magnitude of the pixel (x,y) from the input gradient vector map.

25. The apparatus of claim 17, wherein the abnormal mass candidate outputting device is configured to output, as the abnormal mass candidate, the location of a pixel of the input image in which the iris contrast response value of the pixel is greater than or equal to the minimum iris contrast threshold in the event that no locations exists with a iris ring filter response value that is greater than or equal to the minimum iris ring filter response threshold.

26. A computer-readable medium in which a program executable on a computer for detecting an abnormal mass candidate from an input image is recorded, the program comprising the steps of:
generating an input gradient vector map based on the input image, wherein the input gradient vector map is a map of vector values of pixels of the input image, and wherein the vector value for each pixel represents a direction and a magnitude of a change of the pixel in the input image within a small neighborhood of the pixel;
generating an iris contrast map based on the input gradient vector map, wherein the iris contrast map is a map of iris contrast values of the pixels of the input image, and wherein the iris contrast value for each pixel represents a response value of a corresponding pixel in the input gradient vector map to an iris contrast filter;
generating an iris ring filter response map based on the iris contrast map, wherein the iris ring filter response map is a map of iris ring filter response values of the pixels of the input image, and wherein the iris ring filter response value for each pixel represents a response value of a, corresponding pixel in the iris contrast map to an iris ring filter; and
outputting, as the abnormal mass candidate, a location of a pixel of the input image in which both the iris contrast and the iris ring filter response values of the pixel is greater than or equal to a minimum iris contrast threshold and greater than or equal to a minimum iris ring filter response threshold, respectively.
